(19) United States
(12) Patent Application Publication
(10) Pub. No.: US 2006/0140073 A1
(43) Pub. Date: Jun. 29, 2006

(54) Method and apparatus for automatic adjustment procedure of the optical drive

(75) Inventors: Chang-Der Liu, Hsin-Chu City (TW); Song-Ruei Chen, Hsin-Chu City (TW); Rong-Son Jeng, Hsin-Chu City (TW); Chih-Chang Cheu, Hsin-Chu City (TW); Chun-Cheng Chang, Hsin-Chu City (TW)

Correspondence Address: BIRCH STEWART KOLASCH & BIRCH, PO BOX 747, FALLS CHURCH, VA, 22040-0747, US

(73) Assignee: Lite-On It Corporation

(21) Appl. No.: 11/315,255

(22) Filed: Dec. 23, 2005

(30) Foreign Application Priority Data
Dec. 24, 2004 (TW) 93140487

(51) Int. Cl. G11B 7/00

(52) U.S. Cl. 369/44.28; 369/44.34

(57) ABSTRACT

A method and apparatus for automatic adjustment procedure of optical drive are disclosed. The steps of the method include determining tracking error signals of the inner and the outer zone of the disk, respectively. A difference of the tracking error signal between the inner and the outer-diameter zones of the disk is calculated. The difference of the tracking error signal between the inner diameter and the outer diameter of the disc is compensated.

### BACKGROUND OF THE INVENTION

1. Field of the Invention

This invention relates generally to the art of automatic adjustment procedure for an optical drive. More specifically, this invention relates to the art of automatic adjustment procedure with servo signals.

2. Description of the Prior Art

In comparison of conventional compact disc (CD), digital versatile disc-recordable (DVD-R) with enormous capacity is proposed for the development of recording medium. On a digital versatile disc-recordable disc, pregrooves in the neighbor of lands are used for the information storage, such as video or audio information. The information is recorded in the form of recording pits on the pregrooves.

FIG. 1 is a cross-sectional schematic diagram illustrating a digital disc in the prior art. A DVD disc includes a recording layer 10, multitudes of recording pits 20, pregrooves 30, land 40 and a transparent substrate 50. Generally, the recording layer 10 is made of a phase-change material. During writing, the recording layer 10 on the pregrooves 30 on are first heated by a laser 60 to convert into the recording pits 20 for the information storage. Accordingly, the quality of the recording layer 10 is important to the disc.

The formation of the recording layer 10, for example, would be implemented by spinning-on a dye material on the disc. However, the thickness of the spin-on dye may vary on the disc, for example, the outer zone is generally with the thinner thickness than the inner zone. Accordingly, such a disc may cause the malfunction of the optical drive. Moreover, the quality of the pick-up head or mechanical difference for the optical drive would cause the incorrect reading/writing on the disc.

### SUMMARY OF THE INVENTION

Accordingly, an automatic adjustment process and device is applied to an optical drive for resolving the problem on the difference in the thicknesses of the recording layers. The process and device improves the stability during reading/writing with the gain of servo signals.

In order to resolve the limitation on reading/writing discs for an optical drive, the method and apparatus of automatic adjustment are provided herein. The difference in servo signals respective to an inner- and outer-zones, respectively, is implemented and then compensated. The compensation applied to track on would save time of other processes.

It is one of objects of the present invention to provide an optical drive with an automatic adjustment process to resolve the reading period of an optical disc and cost down. Without any change on the hardware design of the optical drive, correct servo signals would be acquired by compensating the gain of tracking error signal and voltage offset so as to reduce track slipping, error, or failure in writing.

Accordingly, in the process of the automatic adjustment for an optical drive, the difference in the servo signals is decided by the servo signals respective to inner- and outer-diameter zones and then compensated.

### BRIEF DESCRIPTION OF THE DRAWINGS

These and other objects and advantages of the present invention will become more fully apparent from the following detailed description when read in conjunction with the accompanying drawings with like reference numerals indicating corresponding parts throughout, wherein:

FIG. 1 is a cross-sectional schematic diagram illustrating a digital disc in the prior art;

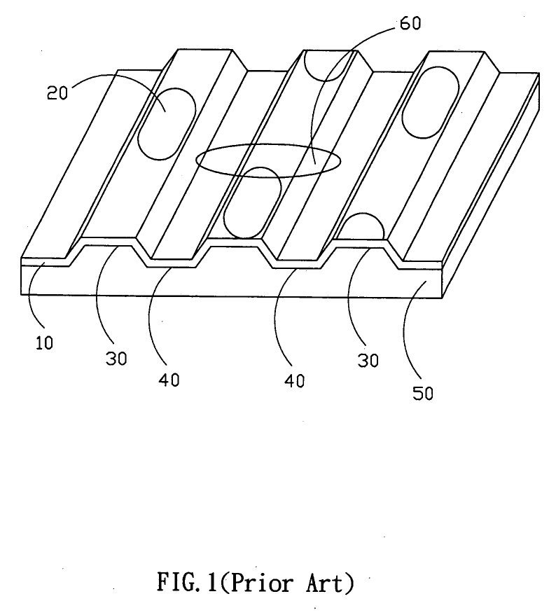

FIG. 2 is a partial schematic flowchart illustrating an optical storage disc read by an optical drives in accordance with the present invention;

FIG. 3A and FIG. 3B are schematic diagrams illustrating the reading/writing data on an optical storage disc with the compensation on the gain of tracking error signal in accordance with one embodiment of the present invention; and

FIG. 4 is a schematic block diagram illustrating DVD optical drive in accordance with the other embodiment of the present invention.

### DESCRIPTION OF THE PREFERRED EMBODIMENT

Reference is now made in detail to specific embodiments of the present invention that illustrate the best mode presently contemplated by the inventors for practicing the invention. It should be understood that the description of the best mode is merely illustrative and that it should not be taken in a limiting sense.

Accordingly, in the process of the automatic adjustment for an optical drive, especially the step of track on, the difference in the servo signals is decided by the servo signals respective to inner- and outer-diameter zones and then compensated.

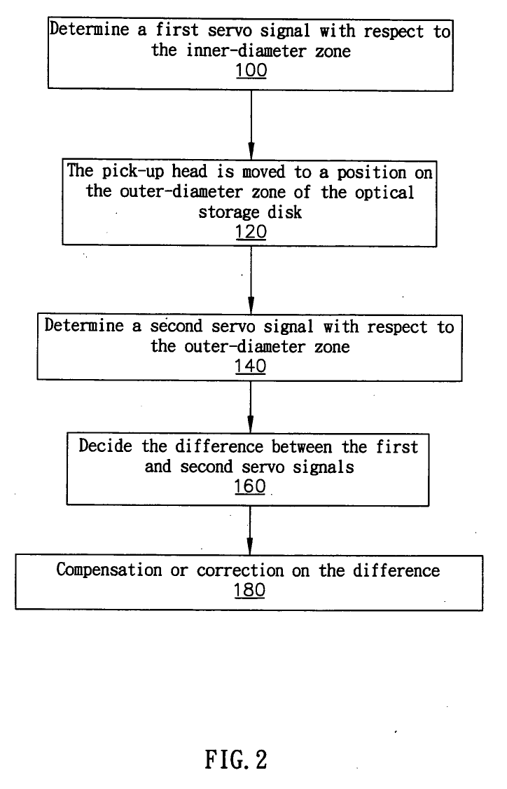

FIG. 2 is a schematic flow diagram illustrating the procedure of reading/writing an optical storage device in accordance with one embodiment of the present invention. Generally speaking, an automatic adjustment procedure is first employed in an optical reading/writing apparatus, such as a DVD optical drive, starts to read/write an optical storage disc, such as CD, CD-R, CD-RW, a single-layered DVD or a double-layered DVD. The automatic adjustment procedure include mainly the step of laser on, step of disk identification, step of focus on, step of spindle on and step of track on, etc. One preferred embodiment of the present invention is applied to the automatic adjustment procedure, but not limited to.

Referring to FIG. 2, an inner signal is acquired by a pick-up head positioned on the inner-diameter zone of an optical storage disk and then transformed into a first servo signal with respect to the inner-diameter zone after analysis (step 100). Next, the pick-up head is moved to a position on the outer-diameter zone of the optical storage disk (step 120) and then collects an outer signal to be transformed into a second servo signal with respect to the outer-diameter zone (step 140). In one embodiment, the first and second servo signals are further processed. In a preferred embodiment, the difference between the first and second servo signals is decided (step 160). The compensation or correction on the difference would be required (step 180).

The difference aforementioned may derive from, on the surface of the optical storage disk, a recording layer with the various thicknesses between the inner-diameter and outer-diameter zones due to a coating procedure. But not limited to, in other condition, the difference may derive from the recording layer with the various reflectivities. It is noted that the inner-diameter zone is a relative region to the outer-diameter zone. In the embodiment, compared to the outer-diameter zone, the inner-diameter zone is near the geometric center of the optical storage disk. In a preferred embodiment, the geometric center of the optical storage disk is positioned on which the optical storage disk is set by the axis center of a motor. Accordingly, the inner-diameter or outer-diameter zones are not limited to one or more specific tracks.

It is understood that some zones with skimpy corresponding servo signals or unintended differences may cause failure in reading or even track slipping. In order to resolve the problems aforementioned, according to one aspects of the present invention, the difference in the various servo signals would be decided by detecting and determining a first servo signal respective to an inner-diameter zone and a second servo signal respective to an outer-diameter zone. In one embodiment of the present invention, the servo signals with linear changes from inner to outer zones are presumed and considered. Accordingly, the gain of tracking error signal and voltage offset for each track are corrected with the first and second servo signals in combination of the linear difference. Thus, the compensation on the difference in the servo signals would be applied to prevent from track slipping.

Accordingly, in the process of the automatic adjustment for an optical drive, especially the step of track on, the difference in the servo signals is decided by the servo signals respective to inner- and outer-diameter zones and then compensated. Thus, the servo signals respective to all zones for an optical storage disc would be substantially equal to each another in amplitudes to improve the stability of the optical drive.

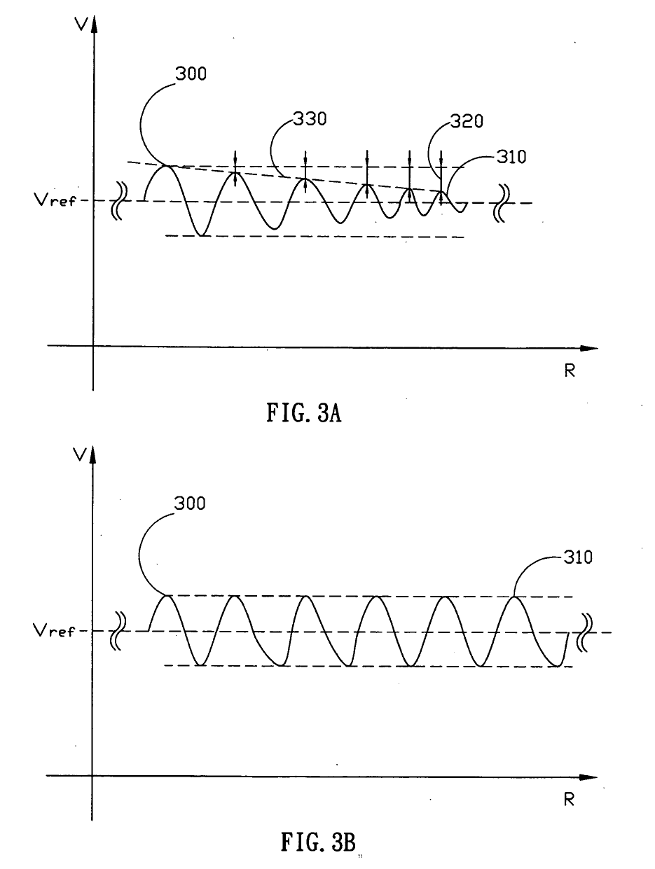

Referring to FIG. 3A and FIG. 3B are schematic diagrams illustrating the reading/writing data on an optical storage disc with the compensation on the gain of tracking error signal in accordance with one embodiment of the present invention. Shown on FIG. 3A, the servo signal is determined after the implementation of automatic adjustment procedure for an optical pick-up head. The vertical axis represents values of voltage (V) and the horizontal axis represents the radius (R) of an optical storage disc. In comparison between the servo signal of inner-diameter zone 300 (the first servo signal) and the servo signal of outer-diameter zone 310 (the second servo signal), the amplitude of the servo signal of outer-diameter zone 310 decreases obviously. Dye layers with the non-uniform thickness on the optical storage disc may cause a reflective beam with a low intensity, such that a weak light signal detected by a receiver is acquired and then transformed into a weak electrical signal. Once the difference between the servo signal of inner-diameter zone 300 and the servo signal of outer-diameter zone is serious too much, the servo signal of outer-diameter zone 310 would not be determined in process of reading/writing actuation or track on, which would elongates the processing time. It is noted that the difference in the servo signals with respect to different zones may happen due to other reasons. However, the method mentioned is not limited to resolve the cause derived from the dye layers with the non-uniform thickness.

In accordance with one aspect of the present invention, at the beginning of the automatic adjustment procedure for the optical drive, the servo signal of inner-diameter zone 300 is first determined followed by the determination of the servo signal of outer-diameter zone 310. Next, the difference 320 in the servo signals is decided followed by the compensation on the gain of the tracking error signal for the difference 320. Thus, the amplitudes of the servo signal of outer-diameter zone 310 and the servo signal of inner-diameter zone 300 are substantially equal and capable to determine the servo signal of outer-diameter zone 310. Furthermore, in addition of compensation on the gain of the tracking error signal for the difference 320, the servo signals responsive to other zones are also compensated correctly. In the embodiment, the differences in servo signals from the inner-diameter zone to the outer-diameter zone are preset to change linearly (represented as a linear relationship 330). Accordingly the differences responsive to other zones are calculated in accordance with the servo signal of inner-diameter zone 300 and the servo signal of outer-diameter zone 310 and further compensated as shown in FIG. 3B. Thus, the amplitudes of the servo signals responsive to all zones are substantially equal.

Accordingly, the differences changing linearly (A(R)) with the radius of the optical disc would be used to determine the compensation for any track. However, the present invention is not limited to be just applied to an amplitude adjustment. Alternatively, linear relationship A(R) 330 would be used to determine the compensation on the servo signal at the moment of track on. Thus, the servo signal in process of track on would be detected correctly.

In the other embodiment, the method of the present invention is capable to resolve the high difference in voltage offset between the servo signal of inner-diameter zone 300 and the servo signal of outer-diameter zone 310. The voltages responsive to the servo signal of inner-diameter zone 300 and the servo signal of outer-diameter zone 310 respectively are first determined followed by the decision of the difference in voltage offset. The compensation on the difference in voltage offset would reduce the influence of the voltage offset on reading/writing date on the optical storage disc.

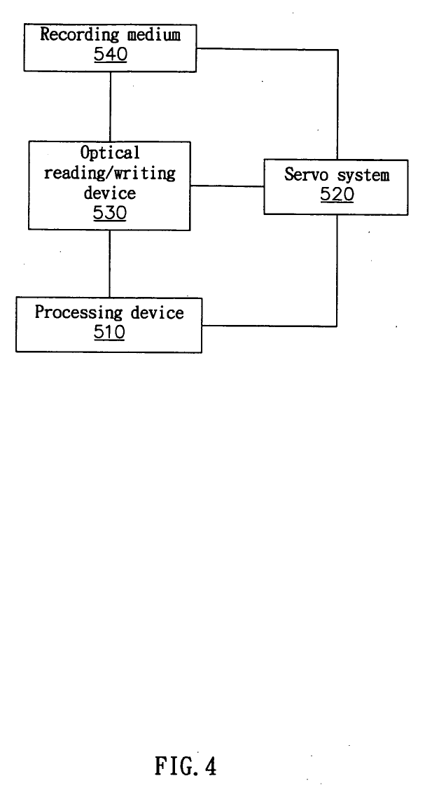

FIG. 4 is a schematic block diagram illustrating DVD optical drive in accordance with the other embodiment of the present invention. The DVD optical drive includes a processing device 510, a servo system 520 and an optical reading/writing device 530.

While tracking, the processing device 510 transmits a control signal to the servo system 520. The servo system 520 generates a tracking action responsive to the control signal so as to drive a recording medium 540 and the servo system 520. The optical reading/writing device 530 detects the optical signal of reflective beam from the recording medium 540 and transforms the optical signal to an electrical signal received and processed by the processing device 510. In accordance with one aspect of the present invention, at the beginning of the automatic adjustment procedure for the optical drive, the servo signal of inner-diameter and outer-diameter zones are determined in sequence Next, the difference 320 in the servo signals is decided and then compensated. Thus, the condition that the processing device 510 fails in receiving the servo signals from the recording medium 540 would not happen.

When there has been illustrated and described what is at present invention considered to be a preferred embodiment of the present invention, it will be understood by those skilled in the art that various changes and modifications may be made, and equivalents may be substituted for elements thereof without departing from the true scope of the invention. In addition, may modifications may be made to adapt a particular situation or material to the teachings of the invention without departing from the true scope thereof. Therefore, it is intended that this invention not be limited to templated for carrying out the invention, but that the invention will include all embodiments falling within the scope of the appended claims.

What is claimed is:

1. A method of automatic adjustment procedure for an optical device, comprising:
determining a servo signal of inner zone and a servo signal of outer zone for an optical storage disc;
deciding a difference in said servo signal of inner zone and said servo signal of outer zone;
acquiring a relation responsive to said difference; and
determining a compensation of servo signal responsive to said relation.

2. The method of automatic adjustment procedure according to claim 1, wherein said step of determining said servo signal of inner zone and said servo signal of outer zone further comprises moving a pick-up head to an outer zone after determining said servo signal of inner zone.

3. The method of automatic adjustment procedure according to claim 1, wherein in comparison with said servo signal of outer zone, said servo signal of inner zone is acquired at a position near a center of said optical storage disc.

4. The method of automatic adjustment procedure according to claim 1, wherein said compensation of servo signal is a gain of tracking error signal during track on.

5. The method of automatic adjustment procedure according to claim 1, wherein said difference comprises an offset of voltage.

6. The method of automatic adjustment procedure according to claim 1, wherein said relation is a linear relation varying with a diameter of said optical storage disc.

7. Apparatus of reading and writing a recording medium, comprising:
processing means for executing a tracking command;
a servo system for driving an action of servo tracing responsive to said tracking command; and
an optical reading and writing device under control of said servo system,
wherein said action of servo tracking drives said optical reading and writing device close to and far away a geometric center of said recording medium so as to, in company with said servo system, determine a servo signal of inner zone and a servo signal of outer zone for said recording medium, and said processing means adjusts a servo signal of track on responsive to a difference between said servo signal of inner zone and said servo signal of outer zone and a relation responsive to said difference.

8. The apparatus of reading and writing a recording medium according to claim 7, wherein said step of driving comprises:
driving said optical reading and writing device close to said geometric center;
determining said servo signal of inner zone;
driving said optical reading and writing device far away said geometric center; and
determining said servo signal of outer zone.

9. The apparatus of reading and writing a recording medium according to claim 7, wherein said processing means is further for compensating and correcting said difference.

10. The apparatus of reading and writing a recording medium according to claim 7, wherein in comparison of said servo signal of outer zone, said servo signal of inner zone is acquired on a position near a geometric center of said recording medium.

11. The apparatus of reading and writing a recording medium according to claim 7, wherein said difference comprises a gain of tacking error signal.

12. The apparatus of reading and writing a recording medium according to claim 7, wherein said difference comprises a voltage offset.

13. The apparatus of reading and writing a recording medium according to claim 7, wherein said step of driving is included in an automatic adjustment process of said servo system.

14. The apparatus of reading and writing a recording medium according to claim 7, wherein said step of adjusting is included in an automatic adjustment process of said servo system.
